(19) United States
(12) Patent Application Publication
(10) Pub. No.: US 2024/0160925 A1
(43) Pub. Date: May 16, 2024

(54) METHOD, APPARATUS, DEVICE, AND MEDIUM FOR DETERMINING UPDATE GRADIENT FOR CONTRASTIVE LEARNING MODEL

(71) Applicant: Beijing Youzhuju Network Technology Co., Ltd., Beijing (CN)

(72) Inventors: Hao Wu, Beijing (CN); Yu Guo, Beijing (CN); Quan Cui, Beijing (CN); Boyan Zhou, Beijing (CN); Cheng Yang, Beijing (CN)

(21) Appl. No.: 18/472,973

(22) Filed: Sep. 22, 2023

(30) Foreign Application Priority Data
Oct. 31, 2022 (CN) 202211352388.2

(51) Int. Cl. G06N 3/08

(52) U.S. Cl. CPC G06N 3/08

(57) ABSTRACT

There are provided method, apparatus, device, and medium for determining update gradient for contrastive learning model. In the method, a gradient factor of a first type for the contrastive learning model is determined based on a first group of training data and a second group of training data for training the contrastive learning model. The gradient factor of the first type is not used for backpropagation during a training process. In a first stage of the training process, a gradient factor of a second type associated with the first group of training data is determined based on the contrastive learning model. The gradient factor of the second type is used for backpropagation during the training process. Gradient is obtained for updating the contrastive learning model based on the gradient factor of the first type and the gradient factor of the second type associated with the first group of training data.

### CROSS-REFERENCE TO RELATED APPLICATIONS

This application claims the benefit of CN Patent Application No. 202211352388.2 filed on Oct. 31, 2022, entitled “METHOD, APPARATUS, DEVICE AND MEDIUM FOR DETERMINING UPDATE GRADIENT FOR CONTRASTIVE LEARNING MODEL”, which is hereby incorporated by reference in its entirety.

### FIELD

Implementations of the present disclosure generally related to machine learning, specifically, to a method, apparatus, device, and computer-readable storage medium for determining update gradient of contrastive learning model.

### BACKGROUND

With the development of machine learning technology, a machine learning model may already be used to perform tasks in various application environments. In order to improve the performance of the model training process, a method based on gradient accumulation has been proposed to integrate multiple batches of training data into larger batches of training data, and then perform the training process. During the training process, parameters of the machine learning model may be updated along the direction of gradient accumulation to obtain an optimized model. However, in the training process of machine learning model based on contrastive learning (referred to as a contrastive learning model), the contribution of various batches of training data to the gradient is not independent, but the contribution of various batches of training data to the gradient also depends on the training data of other batches. This leads to the need to load all batches of training data, which rapidly depletes various resources in the computing device. At this point, how to determine the update gradient of the contrastive learning model has become an urgent problem to be solved.

### SUMMARY

In a first aspect of the present disclosure, a method for determining update gradient for a contrastive learning model is provided. The method comprises: determining a gradient factor of a first type for the contrastive learning model based on a first group of training data and a second group of training data for training the contrastive learning model, the gradient factor of the first type being not used for backpropagation during a training process of the contrastive learning model; determining, in a first stage of the training process, a gradient factor of a second type associated with the first group of training data based on the contrastive learning model, the gradient factor of the second type associated with the first group of training data being used for backpropagation during the training process; and obtaining gradient for updating the contrastive learning model based on the gradient factor of the first type and the gradient factor of the second type associated with the first group of training data.

In a second aspect of the present disclosure, an apparatus for determining update gradient of a contrastive learning model is provided. The apparatus comprises: a first determination unit configured to determine a gradient factor of a first type for the contrastive learning model based on a first group of training data and a second group of training data for training the contrastive learning model, the gradient factor of the first type being not used for backpropagation during a training process of the contrastive learning model; a second determination unit configured to determine, in a first stage of the training process, a gradient factor of a second type associated with the first group of training data based on the contrastive learning model, the gradient factor of the second type associated with the first group of training data being used for the backpropagation during the training process; and a obtaining unit configured to obtain gradient for updating the contrastive learning model based on the gradient factor of the first type and the gradient factor of the second type associated with the first group of training data.

In a third aspect of the present disclosure, an electronic device is provided. The device comprises at least one processing unit; and at least one memory coupled to the at least one processing unit and storing instructions to be executed by the at least one processing unit, the instructions, when executed by the at least one processing unit, causing the device to perform the method of the first aspect.

In a fourth aspect of the present disclosure, a computer-readable storage medium is provided. The medium has a computer program stored thereon which, when executed by a processor, performs the method of the first aspect.

In a fifth aspect of the present disclosure, a method for data processing is provided. The method comprises determining update gradient for a contrastive learning model using the method of the first aspect; training the contrastive learning model based on the update gradient; and determining an association relationship between data in a sample to be processed using the trained contrastive learning model.

In a sixth aspect of the present disclosure, an apparatus for data processing is provided. The apparatus comprises a determination unit configured to determine update gradient for a contrastive learning model using an apparatus of the fifth aspect; a training unit configured to train the contrastive learning model based on the update gradient; and a determination unit configured to determine an association relationship between data in a sample to be processed using the trained contrastive learning model.

It would be appreciated that the content described in the Summary section of the present invention is neither intended to identify key or essential features of the implementations of the present disclosure, nor is it intended to limit the scope of the present disclosure. Other features of the present disclosure will be readily envisaged through the following description.

### BRIEF DESCRIPTION OF THE SEVERAL VIEWS OF THE DRAWINGS

The above and other features, advantages and aspects of the implementations of the present disclosure will become more apparent in combination with the accompanying drawings and with reference to the following detailed description. In the drawings, the same or similar reference symbols refer to the same or similar elements, where:

FIG. 1A illustrates a schematic diagram of an example environment in which implementations of the present disclosure may be implemented;

FIG. 1B illustrates a process for determining update gradient for a machine learning model according to a technical solution;

FIG. 2 illustrates a block diagram of a structure of a machine learning model based on contrastive learning according to some implementations of the present disclosure;

FIG. 3 illustrates a block diagram of a process for determining update gradient for a contrastive learning model according to some implementations of the present disclosure;

FIG. 4 illustrates a block diagram of training data including multiple modalities according to some implementations of the present disclosure;

FIG. 5 illustrates a block diagram for determining training data according to some implementations of the present disclosure;

FIG. 6 illustrates a block diagram of a process for determining update gradient of a contrastive learning model describing a unidirectional association relationship from image to text according to some implementations of the present disclosure;

FIG. 7 illustrates a block diagram of a process for determining a contrastive learning model for describing a unidirectional association relationship from text to image according to some implementations of the present disclosure;

FIG. 8 illustrates a block diagram of the process of determining a contrastive learning model for describing a bidirectional association relationship between images and text according to some implementations of the present disclosure;

FIG. 9 illustrates a flowchart of a method for determining the update gradient of a contrastive learning model according to some implementations of the present disclosure;

FIG. 10 illustrates a block diagram of an apparatus for determining an update gradient of a contrastive learning model according to some implementations of the present disclosure; and

FIG. 11 illustrates an electronic device in which one or more implementations of the present disclosure may be implemented.

### DETAILED DESCRIPTION

The implementations of the present disclosure will be described in more detail below with reference to the accompanying drawings. Although some implementations of the present disclosure are shown in the drawings, it would be appreciated that the present disclosure can be implemented in various forms and should not be interpreted as limited to the implementations described herein. On the contrary, these implementations are provided for a more thorough and complete understanding of the present disclosure. It would be appreciated that the drawings and implementations of the present disclosure are only for illustrative purposes and are not intended to limit the scope of protection of the present disclosure.

In the description of the implementations of the present disclosure, the term “includes” and its variants are to be read as open terms that mean “includes, but is not limited to.” The term “based on” is to be read as “based at least in part on.” The terms “one implementation” or “the implementation” are to be read as “at least one implementation.” The term “some implementations” is to be read as “at least some implementations.” Other definitions, either explicit or implicit, may be included below. As used herein, the term “model” may refer to an association relationship between various data. For example, the above association relationship may be obtained based on various technical solutions currently known and/or to be developed in the future.

It is to be understood that data involved in the present technical solution (including but not limited to the data itself, the acquisition or use of the data) should comply with requirements of corresponding laws and regulations and relevant rules.

It is to be understood that, before applying the technical solutions disclosed in various implementations of the present disclosure, the user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the subject matter described herein.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

### Example Environment

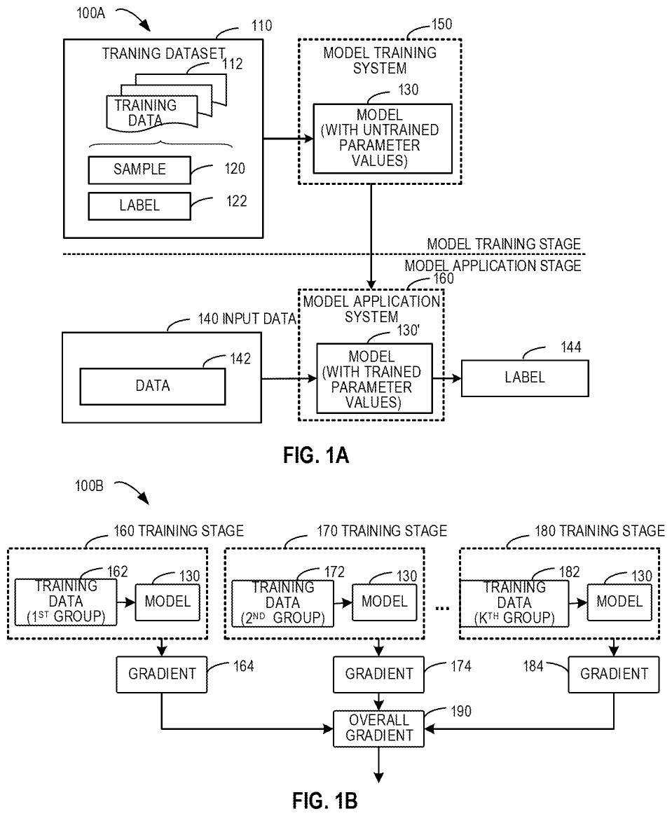

FIG. 1A illustrates a block diagram of an environment 100 capable of implementing multiple implementations of the present disclosure. In the environment 100 of FIG. 1, it is expected to train and apply such a machine learning model (i.e., a model 130), which is configured for various application scenarios, for example, for identifying image content, and so on. As shown in FIG. 1A, the environment 100 includes a model training system 150 and a model application system 160. The upper part of FIG. 1A illustrates a process of model training stage, and the lower part illustrates a process of model application stage. Before training, parameter values of the model 130 may have initial values or have pre-trained parameter values obtained through a pre-training process. The model 130 may be trained through forward propagation and backward propagation, and the parameter values of the model 130 may be updated and adjusted during the training process. After the training is completed, a model 130′ may be obtained. At this point, the parameter values of the model 130′ have been updated, and the model 130 may be used to achieve prediction tasks based on the updated parameter values in the model application stage.

In the model training stage, the model 130 may be trained using the model training system 150 based on a training dataset 110 that includes multiple training data 112. Here, each training data 112 may relate to a two-tuples format and include a sample 120 and a label 122 related to the to-be-processed task. At this point, the model 130 may be trained using the training data 112 including the sample 120 and the label 122. Specifically, a large amount of training data may be utilized to iteratively perform the training process. After the training is completed, the model 130 may include knowledge about the tasks to be processed. In the model application stage, the model application system 160 may be used to call the model 130′ (at this time, the model 130′ has trained parameter values). For example, it is possible to receive input 142 that the model will process and output a corresponding answer (i.e., output 144) to the to-be-processed task.

In FIG. 1A, the model training system 150 and the model application system 160 may include any computing system with computing capability, for example various computing devices/systems, terminal devices, servers, etc. The terminal devices may relate to any type of mobile terminals, fixed terminals or portable terminals, including a mobile phone, a desktop computer, a laptop computer, a notebook computer, a netbook computer, a tablet computer, a media computer, a multimedia tablet, or any combination thereof, including accessories and peripherals of these devices or any combination thereof. Servers include but are not limited to mainframes, edge computing nodes, computing devices in a cloud environment, etc.

It would be appreciated that components and arrangements in the environment shown in FIG. 1A are only examples, and a computing system suitable for implementing the example implementations described in the present disclosure may include one or more different components, other components, and/or different arrangements. For example, although shown as separate, the model training system 150 and the model application system 160 may be integrated into a same system or device. The implementations of the present disclosure are not limited in this regard. The following will continue to refer to the accompanying drawings to describe example implementations of model training and model application respectively.

At present, technical solutions of gradient accumulation have been proposed, and in most machine learning tasks, gradient accumulation is usually used to increase the amount of training data in batches. During the training process, the training data 112 in the training dataset 110 may be divided into multiple batches (i.e., groups). The training process may be performed using training data in multiple batches in multiple stages. By gradient accumulation, an equivalent batch size with any amount of training data may be achieved. At this point, the gradient generated by the loss of a single training data is independent, and the gradient generated by the loss of all training data in the batch may be equivalently represented by the accumulation of gradients generated by the loss of each training data.

FIG. 1B illustrates a process 100B for determining update gradient of a machine learning model according to a technical solution. As shown in FIG. 1B, the training data may be divided into multiple groups. In training stage 160, a first group of training data 162 may be used to train a model 130. In training stage 170, a second group of training data 172 may be used to train the model 130. In training stage 180, a K-th group of training data 182 may be used to train the model 130. In each training stage, gradients 164, 174 . . . , 184 for backpropagation may be determined separately, and then an overall gradient 190 for updating parameters of the model 130 may be determined based on the accumulation of each gradient.

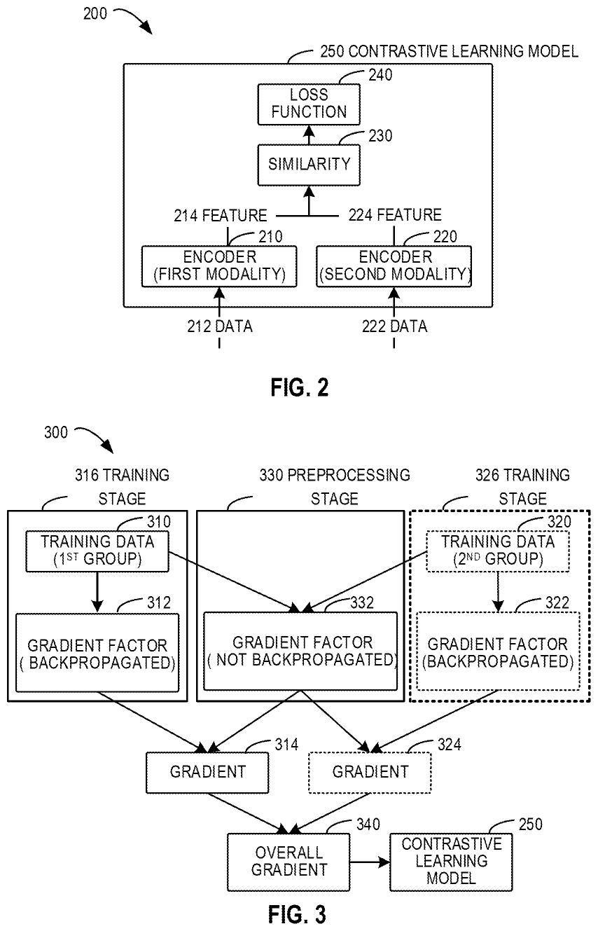

Although gradient accumulation may be suitable for most machine learning tasks, this technical solution is not suitable for contrastive learning models. Refer to FIG. 2 for an overview of a contrastive learning model, which illustrates a block diagram 200 of the structure of a machine learning model based on contrastive learning according to some implementations of the present disclosure. As shown in FIG. 2, a contrastive learning model 250 may include two encoders 210 and 220, data 212 and 222 (data 212 and 222 may be referred to as sample pairs) may be inputted into the two encoders 210 and 220 and corresponding features 214 and 224 may be obtained, respectively. At this time, the contrastive learning model 250 will determine a similarity 230 between the two features, and then determine a loss function 240.

The loss function 240 may learn from the feature of a positive sample pair (that is, a sample pair with similar data) and a negative sample pair (that is, a sample pair with dissimilar data) by pulling closer the features of the positive sample pair, and then gradually optimize the contrastive learning model 250. However, the gradients generated by the loss of training data in various batches are not independent of each other, but the gradients generated by the loss of training data in various batches not only depend on the training data in the batch where the training data is located, but also on the training data in other batches. At this point, even if the training data is divided into multiple batches, it is still necessary to load all the training data from multiple batches simultaneously when determining the gradient. This may lead to rapid depletion of resources in computing devices. At this point, how to determine the update gradient of contrastive learning models in a more effective way has become a difficult and hot topic in the field of contrastive learning.

### Brief Process for Determining Update Gradient

In order to at least partially remove the drawbacks described above, a method for determining update gradient of a contrastive learning model is provided according to an example implementation of the present disclosure. Specifically, influencing factors of the gradient of the contrastive learning model 250 may be divided into two parts: a part associated with the training data in all of the multiple batches (i.e., a gradient factor of a first type), and a part only related to the training data in the current batch (i.e., a gradient factor of a second type). According to an example implementation of the present disclosure, the gradient factor of the first type is determined based on training data from multiple groups, and thus may be referred to as a global gradient factor. The gradient factor of the second type is only determined based on the current training data of a single group, so it may be referred to as a local gradient factor.

In the following, the details of an example implementation according to the present disclosure will be described by dividing the training data into only two batches as an example. Assuming that the training dataset includes 2048 training data, it may be divided into two groups (i.e., a first group of training data and a second group of training data), and each group includes 1024 training data. Refer to FIG. 3 for an overview of an example implementation according to the present disclosure, which illustrates a block diagram 300 of the process for determining the update gradient of a contrastive learning model according to some implementations of the present disclosure.

As shown in FIG. 3, the training process may be completed through two different types of stages. Specifically, the training process may include a preprocessing stage 330; Furthermore, the training process may include training stages 316 and 326. According to an example implementation of the present disclosure, the preprocessing stage 330 may determine a gradient factor 332 of the first type of the contrastive learning model 250 from two sets of training data. Here, the gradient factor 332 represents the portion that is not used for backpropagation during the training process of the contrastive learning model 250. In other words, in the pre-processing stage 330, two sets of training data may be traversed in advance and the corresponding gradient factor 332 may be determined. The determined gradient factor 332 may be cached in the memory of the computing device for recall in subsequent training stages.

According to an example implementation of the present disclosure, different groups of training data may be used in training stages 316 and 326. In other words, a group of training data may be used for training in each batch. Here, the number of training stages is determined based on the number of training data groups, and the more groups there are, the more training stages there are. According to an example implementation of the present disclosure, each training stage may use its own training data to determine the gradient factor associated with that training stage. For example, in the training stage 316, the corresponding gradient factor 312 may be determined based on the first group of training data 310. Further, based on the cached gradient factor 332 of the first type and the gradient factor 312 of the second type associated with the first group of training data, a gradient 314 may be determined for updating the contrastive learning model 250. It will be understood that the gradient 314 here is obtained from the single training stage 316, and in the process of determining the gradient 314, only the first group of training data 310 needs to be loaded into the computing device simultaneously.

Using the example implementation of the present disclosure, the training data loaded in the training stage 316 is limited to 1024 training data in the first group of training data 310, and no other group of training data needs to be loaded. Therefore, the process of determining the gradient factor 312 may be independent of other training stages. Compared to the conventional technical solution that requires loading training data for all groups in the computing device (for example, in the case of two groups, 1024*2=2048 training data needs to be loaded), the example implementation of the present disclosure may greatly reduce the amount of data loaded in a training stage, thereby alleviating the problem of resource depletion in the computing device.

It will be understood that although the above only describes the processing process in the single training stage 316, the processing process in other training stages is also similar. For example, in the training stage 326, the corresponding gradient factor 322 may be determined based on the second group of training data 320. Here, the gradient factor 322 will be used for backpropagation to update the parameters of the contrastive learning model 250. At this point, based on the cached gradient factor 332 of the first type and the gradient factor 322 of the second type associated with the second group of training data, the gradient 324 may be determined for updating the contrastive learning model. It will be understood that the gradient 324 here is obtained from the single training stage 326, and in the process of determining the gradient 324, only the second group of training data 320 needs to be loaded into the computing device simultaneously.

Further, the overall gradient 340 for updating the contrastive learning model 250 may be determined based on gradients 314 and 324. For example, the overall gradient 340 may be determined based on the sum of gradients 314 and 324. In this way, the process of determining gradient updates may be transformed into simple mathematical operations, thereby optimizing the contrastive learning model 250 in a simpler and more effective way.

It will be understood that although FIG. 3 only exemplarily illustrates the case of dividing the training dataset into two groups. Alternative and/or additional, N training data may be divided into multiple groups according to a predetermined size M. At this point, each group may include M training objects, and N/M groups will be generated. Then, the training data of the N/M groups mentioned above may be processed separately in N/M training stages, and the gradient factor associated with each group may be determined. Each group may be processed according to the method described above. Specifically, all the N training data may be traversed during the preprocessing stage to determine and cache the gradient factor 332 that are not back propagated.

Further, in each training stage, the training data of the relevant groups in the current training stage may be utilized to generate the local gradient factor that requires backpropagation. Then, the gradient of the current training stage may be generated based on the determined local gradient factor and the cached global gradient factor. Each training stage may be processed in a similar manner and the gradients determined from various training stages may be summed to obtain the overall gradient 340.

At this point, the overall gradient 340 is the update gradient that is determined from N training data. The overall gradient 340 is equivalent to the update gradient that is determined by simultaneously loading all N training data into the computing device. However, in the process of determining the overall gradient 340, only N/M training data needs to be loaded simultaneously. Compared to conventional technical solutions, the proposed technical solution may reduce the workload of computing devices to 1/M of the original workload, thereby alleviating the problem of insufficient computing resources.

### Detailed Process for Determining Update Gradient

The summary process for determining the update gradient has been provided above, and more detailed information on determining the update gradient will be provided below. In the context of the present disclosure, a machine learning model for processing the association relationship between an image and a text will be used as an example of the contrastive learning model 250 to describe more information on determining update gradients. The contrastive learning model 250 here may describe whether the content of the image and the text is consistent. For example, if the image includes a horse and the horse is eating grass, and the text includes “a horse is eating grass”, then the content of the image and the text is consistent. Assuming the text includes “a cattle is eating grass”, the content of the image and the text is inconsistent. According to an example implementation of the present disclosure, the contrastive learning model may be trained using training data including image, text, and label.

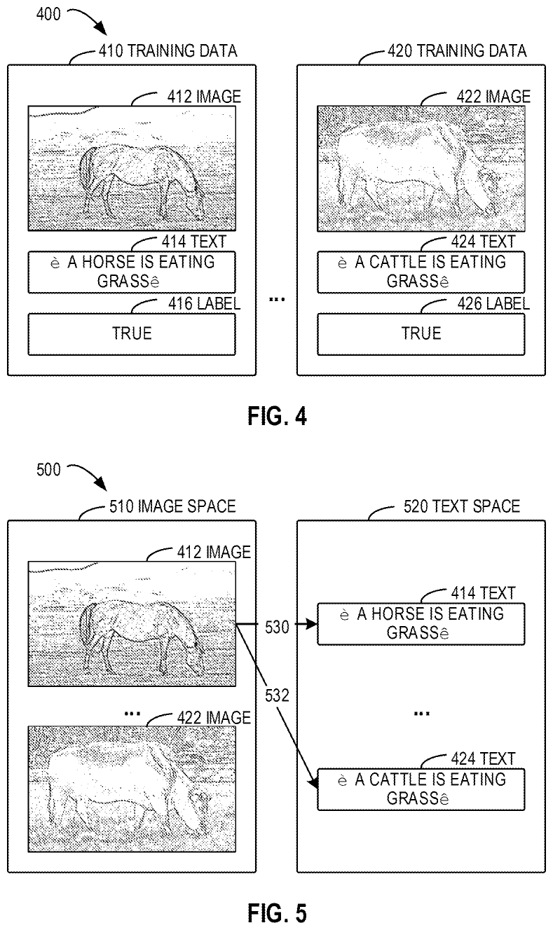

According to an example implementation of the present disclosure, each group of training data may include multiple training data, and each training data may involve different modal. Refer to FIG. 4 for more details on training data, which illustrates a block diagram 400 of training data including multiple modalities according to some implementations of the present disclosure. As shown in FIG. 4, there may be multiple training data 410 . . . , and 420. The training data 410 may include an image 412 (that is, the data of a first modal), a text 414 (that is, the data of a second modal), and a label 416 representing an association relationship between the data of the first modality and the data of the second modal. Due to the consistency between the content of the image 412 and the text 414, the label 416 is “true” at this time.

Further, the training data 420 may include an image 422, a text 424, and a label 426 describing the content consistency between the image 422 and the text 424. Due to the consistency between the content of the image 422 and the text 424, the label 426 is also “true” at this time. In the context of the present disclosure, the training data labeled as true may be referred to as positive samples. Although FIG. 4 only illustrates positive samples, negative samples may still exist. For example, if a certain training data includes the image 412 and the text 424, the content of the image and the text is inconsistent. The label of this training data is “false” and it may be referred to as a negative sample.

It will be understood that, although an example where the first modality is image and the second modality is text has been described above, alternatively and/or additionally, the first modality and the second modality may be interchanged. Alternatively and/or additionally, the first modality and the second modality may also involve the same data format, for example, in an image processing (e. g., cropping, flipping, etc.) environment, both modals may involve images. According to an example implementation of the present disclosure, the first modality and the second modality may also involve other formats, including but not limited to images, text, video, audio, and the like.

It will be understood that providing more negative sample data during each training stage of contrastive learning helps to obtain more knowledge by the contrastive learning model 250. Therefore, more negative samples may be constructed based on the obtained positive samples to improve the efficiency of the training process. According to an example implementation of the present disclosure, positive samples of training data may be obtained from the training data set of the contrastive learning model 250. Further, the data space of the two modalities in the positive samples may be determined. FIG. 5 illustrates a block diagram 500 for determining training data according to some implementations of the present disclosure.

As shown in FIG. 5, an image space 510 where the image data is located may be determined, which may include images from various training data, such as images 412 . . . , and 422. Further, a text space 520 where the text data is located may be determined, which may include texts from various training data, such as texts 414 . . . , and 424. According to an example implementation of the present disclosure, an image in the image space 510 may be combined with a text in the text space 520 to form a data pair, and a corresponding label may be determined based on the content consistency of the image and text. Specifically, the first data of the first modality (for example, the image 412 in the image space 510) may be combined with other data (for example, the third data, for example, the text 414 in the text space 520) other than the second data (for example, the text 414 in the text space 520) of the second modality to generate negative samples.

As shown by an arrow 530 in FIG. 5, the image 412 may be combined with the text 414, where the label is “true” and a positive sample is generated. As shown by an arrow 532, the image 412 may be combined with the text 424, where the label is “false” and a negative sample is generated. According to an example implementation of the present disclosure, each grouping may include a positive sample and multiple negative samples generated based on the positive sample. Assuming that the image space 510 includes 1024 images and the text space 520 includes 1024 texts, the first image in the image space 510 may be combined with 1024 texts in the text space 520 to generate 1 positive sample and 1023 negative samples. Further, the second image in the image space 510 may be combined with 1024 texts in the text space 520 to generate 1 positive sample and 1023 negative samples. In this way, the number of training data may be greatly increased, thereby the accuracy of contrastive learning models is improved.

According to an example implementation of the present disclosure, the contrastive learning model 250 may describe the forward association relationship between the data of the first modality and the data of the second modal. Alternatively and/or additionally, the contrastive learning model 250 may describe the backward association relationship from the data of the second modality to the data of the first modal. Alternatively and/or additionally, the contrastive learning model 250 may describe the bidirectional association relationship between the data of the first modality and the data of the second modal. For the convenience of description, the forward association relationship between the data of the first modality and the data of the second modality is taken as an example to describe the specific formula for determining the loss function and then determining the corresponding gradient.

According to an example implementation of the present disclosure, the loss function (also referred to as InfoNCE (Noise Contrastive Estimation, abbreviated as NCE)) of the contrastive learning model 250 may be determined based on various ways, and then the loss function may be used to train the contrastive learning model 250. According to the definition of InfoNCE, the overall loss function [symbol] across multiple groups may be represented based on the following formula 1.

$$ℒ = {ℒ}^{I 2 T} = - {\sum }_{i} log ( \frac{exp ( \frac{{s}_{i}^{⊤} ( I ) {s}_{i} ( T )}{t} )}{{\sum }_{j} exp ( \frac{{s}_{i}^{⊤} ( I ) {s}_{j} ( T )}{t} )} ) \qquad formula 1$$

In the formula 1, the symbol I represents the image and the symbol T represents the text, [symbol] ^{I2T} represents the loss related to the forward association relationship from the image to the text, i represents the i^{th} data in the image space, j represents the j^{th} data in the text space, and sᵢ(I) and sᵢ(T) represents the corresponding features of the i^{th} data in the image space and the text space, respectively (i.e., the image and text features determined by the encoders 210 and 220 in the contrastive learning model 250, respectively). Further, the symbol t represents the temperature involved in determining the loss function, and the meaning of other mathematical symbols is the same as that of the symbols in the art.

When the contrastive learning model 250 describes the backward association relationship between the text and the image, the loss function may be represented as formula 2. Further, when the contrastive learning model 250 describes the bidirectional association relationship between the text and the image, the loss function may be represented as formula 3. The symbols in each formula have the same meaning as formula 1, so they will not be repeated.

$$ℒ = {ℒ}^{T 2 I} = - {\sum }_{i} log ( \frac{exp ( \frac{{s}_{i}^{⊤} ( T ) {s}_{i} ( I )}{t} )}{{\sum }_{j} exp ( \frac{{s}_{i}^{⊤} ( T ) {s}_{j} ( I )}{t} )} ) \qquad formula 2$$

$$ℒ = {ℒ}^{I 2 T} + {ℒ}^{T 2 I} = - {\sum }_{i} log ( \frac{exp ( \frac{{s}_{i}^{⊤} ( I ) s ( T )}{t} )}{{\sum }_{j} exp ( \frac{{s}_{i}^{⊤} ( I ) {s}_{j} ( T )}{t} )} ) - {\sum }_{i} log ( \frac{exp ( \frac{{s}_{i}^{⊤} ( T ) {s}_{i} ( I )}{t} )}{{\sum }_{j} exp ( \frac{{s}_{i}^{⊤} ( T ) {s}_{j} ( I )}{t} )} ) \qquad formula 3$$

According to an example implementation of the present disclosure, the overall loss function [symbol] described in the formulas 1 to 3 above may be split into a loss function [symbol] ᵢ of the individual training data. Formulas 4, 5 and 6 respectively represent a related loss function of the contrastive learning model of a unidirectional association relationship from the image to the text, a related loss function of the contrastive learning model of a unidirectional association relationship from the text to the image, and a related loss function of the contrastive learning model of a bidirectional management relationship between image and text.

$${ℒ}_{i} = {ℒ}_{i}^{T 2 I} = - log ( \frac{exp ( \frac{{s}_{i}^{⊤} ( T ) {s}_{i} ( I )}{t} )}{{\sum }_{j} exp ( \frac{{s}_{i}^{⊤} ( T ) {s}_{j} ( I )}{t} )} ) \qquad formula 4$$

$${ℒ}_{i} = {ℒ}_{i}^{I 2 T} = - log ( \frac{exp ( \frac{{s}_{i} ( I ) {s}_{i} ( T )}{t} )}{{\sum }_{j} exp ( \frac{{s}_{i} ( I ) {s}_{j} ( T )}{t} )} ) \qquad formula 5$$

$${ℒ}_{i} = {ℒ}_{i}^{I 2 T} + {ℒ}_{i}^{T 2 I} = - log ( \frac{exp ( \frac{{s}_{i}^{⊤} ( I ) s ( T )}{t} )}{{\sum }_{j} exp ( \frac{{s}_{i}^{⊤} ( I ) {s}_{j} ( T )}{t} )} ) - log ( \frac{exp ( \frac{{s}_{i}^{⊤} ( T ) {s}_{i} ( I )}{t} )}{{\sum }_{j} exp ( \frac{{s}_{i}^{⊤} ( T ) {s}_{j} ( I )}{t} )} ) \qquad formula 6$$

In the formulas 4 to 6, symbol [symbol] ᵢ represents the loss function of the individual training data, and symbols [symbol] ᵢ^{I2T} and [symbol] ᵢ^{T2I} respectively represent the forward and backward loss function generated by the individual training data. The symbols in each formula have the same meanings as the other formulas described above, so they will not be repeated.

It may be seen from the formulas 4 to 6 that the loss function [symbol] ᵢ generated by the individual training data is related to all training data in the group. In other words,

$$exp ( \frac{{s}_{i}^{⊤} ( I ) {s}_{j} ( T )}{t} ) and / or exp ( \frac{{s}_{i}^{⊤} ( T ) {s}_{j} ( I )}{t} )$$

in each formula depend on sᵢ(I) and sᵢ(T) of the individual training data within the group. This results in only obtaining the features of M training data within the current group when using the existing gradient accumulation technical solutions, but not the features of N-M training data within other groups. This makes it impossible to determine the loss function and the corresponding gradient based on the above formulas.

According to an example implementation of the present disclosure, a technical solution is proposed to split the process of determining gradients into two stages. In the preprocessing stage 330, a global gradient factor that does not require backpropagation may be determined based on training data from multiple groups. Further, in the subsequent training stages of processing each group, the local gradient factor that requires backpropagation may be determined based on the training data of the current group. In the following, more details on determining global and local gradient factors will be described in conjunction with specific formulas.

It will be understood that in the process of determining the gradient, the temperature t during the learning process is omitted for simplicity. In the specific calculation process, the temperature t may be integrated into the process of determining the features of images and/or texts. In the example of the contrastive learning model 250 for the association relationship between images and texts, based on the formulas 1 and 4 above, the gradient of the loss of all N training data for the parameter (θ) of the contrastive learning model may be determined (see formula 7).

$$\begin{matrix}{∇}_{θ} {ℒ}^{I 2 T} = {\sum }_{{i}^{( I )}} {\sum }_{{{j}^{( T )}}^{}} ( {\overline{p}}_{i j}^{I 2 T} - {y}_{i j}^{I 2 T} ) {\overline{s}}_{i} ( I ) {∇}_{θ} {s}_{j} ( T ) + {\sum }_{{i}^{( I )}} {\sum }_{{j}^{( T )}} ( {\overline{p}}_{i j}^{I 2 T} - {y}_{i j}^{I 2 T} ) {\overline{s}}_{j} ( T ) {∇}_{θ} {s}_{i} ( I ) \\ = [ {\sum }_{{j}^{( T )}}^{{B}^{( T )}} {∇}_{θ} {( {{\sum }^{{B}^{( I )}}}_{{i}^{( I )}} ( {\overline{p}}_{i j}^{I 2 T} - {y}_{i j}^{I 2 T} ) {\overline{s}}_{i} ( I ) )}^{⊤} {s}_{j} ( T ) ] + [ {{\sum }^{{B}^{( I )}}}_{{i}^{( I )}} {∇}_{θ} {( {\sum }_{{j}^{( T )}}^{{B}^{( T )}} ( {\overline{p}}_{i j}^{I 2 T} - {y}_{i j}^{I 2 T} ) {\overline{s}}_{j} ( T ) )}^{⊤} {s}_{i} ( I ) ]\end{matrix} \qquad formula 7$$

In formula 7, ∇_{θ} [symbol] ^{I2T} represents, in the association relationship between images and texts, the gradient of the loss of all N training data for the parameter (θ) of the contrastive learning model, p̅ᵢⱼ^{-I2T} represents a predicted value, yᵢⱼ^{I2T} represents a label, s̅ᵢ(I) and s̅ⱼ(T) represent features of image data and text data, respectively. B^{(I)} and B^{(T)} represent the amount of data in image space and text space, respectively. In the formula 7, symbols with a horizontal line at the top (such as p̅ᵢⱼ^{I2T}, s̅ⱼ(I), s̅ⱼ(T)) represent the data without the gradient, and symbols without a horizontal line at the top (such as sⱼ(T), sᵢ(I),) represent the data with the gradient. At this point, a formula 8 may be derived from the formula 7 through mathematical transformation.

$${∇}_{θ} ℒ = {∇}_{θ} {ℒ}^{I 2 T} = [ {\sum }_{{i}^{( I )}}^{{B}^{( I )}} {∇}_{θ} {( {\sum }_{{j}^{( T )}}^{{B}^{( T )}} ( {\overline{p}}_{i j}^{I 2 T} - {y}_{i j}^{I 2 T} ) {\overline{s}}_{j} ( T ) )}^{⊤} {s}_{i} ( I ) ] + [ {\sum }_{{j}^{( T )}}^{{B}^{( T )}} {∇}_{θ} {( {\sum }_{{i}^{( I )}}^{{B}^{( I )}} ( {\overline{p}}_{i j}^{I 2 T} - {y}_{i j}^{I 2 T} ) {\overline{s}}_{i} ( I ) )}^{⊤} {s}_{j} ( T ) ] \qquad formula 8$$

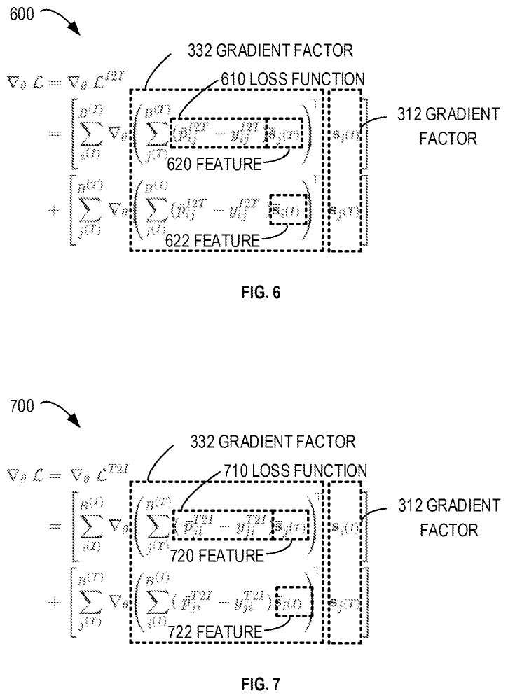

At this point, the formula 8 may be represented as a global gradient factor associated with all N training data and a local gradient factor associated only with M training data in the current group. Refer to FIG. 6 to describe more details about global and local gradient factors. FIG. 6 illustrates a block diagram 600 of a process for determining the update gradient of a contrastive learning model describing a unidirectional association relationship from image to text according to some implementations of the present disclosure.

As shown in FIG. 6, the gradient factor 332 represents the global gradient factor, in other words, the gradient factor 332 needs to be determined based on N training data. Specifically, all N training data may be traversed and the loss function associated with each training data may be determined. In the preprocessing stage, the contrastive learning model 250 may be used to determine the predicted value p̅ᵢⱼ^{I2T} associated with each training data, and the true value yᵢⱼ^{I2T} of the corresponding label may be determined from the training data. Further, the loss function (p̅ᵢⱼ^{I2T}−yᵢⱼ^{I2T}) may be determined based on the difference between the predicted value and the label in the training data. It will be understood that the above process only involves simple mathematical operations, so it only needs to traverse each training data to determine the corresponding a loss function 610.

Further, the contrastive learning model may be used to determine a first feature of the data of the first modality (that is, a feature 620 shown in FIG. 6) and a second feature of the data of the second modality (that is, a feature 622 shown in FIG. 6) respectively. In other words, the encoder 210 of the first modality and the encoder 220 of the second modality in the contrastive learning model 250 may be directly called to determine the features 620 and 622 shown in FIG. 6.

According to an example implementation of the present disclosure, the encoder 210 may describe the association relationship between image data and image features of image data, and the encoder 220 may describe the association relationship between text data and text features of text data. In the initial stage, the encoders 210 and 220 may be untrained and/or partially trained image encoders and text encoders, respectively. During the process of training the contrastive learning model 250, the encoders 210 and 220 may be continuously optimized. Further, according to the definition of Formula 8, based on the loss function 610, the features 620 and 622, the gradient factor 332 of the global type may be determined.

According to an example implementation of the present disclosure, the gradient factor 332 may be determined during the preprocessing stage. Specifically, computing devices may be used to traverse N training data and determine the corresponding loss function 610, features 620 and 622, and then determine the corresponding gradient factor 332. Further, the determined gradient factor 332 may be cached as a variable in the storage space of the computing device for future use. In this way, the preprocessing stage may decouple the training data of each group from the training data of other groups. In this way, it may be ensured that in subsequent training stages, only the training data of the current group needs to be loaded, without the need to load training data from other groups.

The process of determining the global gradient factor has been described, and how to determine the local gradient factor will be described in the following. Here, the local gradient factor includes the feature sᵢ(I) of the data of the first modality and the feature sⱼ(T) of the data of the second modality in the given training data of the first group of training data. That is, as shown in FIG. 6, local gradient factors may include the gradient factors 312 and 322. At this point, the two features mentioned above may be determined using the encoders 210 and 220 in the contrastive learning model 250, respectively.

When the global gradient factor 332 and the local gradient factor 312 have been determined, the gradient caused by the loss of training data in the current group may be determined based on the formula 8. Specifically, in the training stage 316, the gradient from the first group of training data 310 may be determined.

According to an example implementation of the present disclosure, the training data of each group may be processed in a similar manner. For example, in the training stage 326 after the training stage 316, the second group of training data 320 may be processed in a similar manner. Specifically, the local gradient factor 322 associated with the second group of training data 320 may be determined based on the contrastive learning model 250 and the second group of training data 320. Further, the gradient 324 for the training stage 326 may be generated based on the global gradient factor 332 and the local gradient factor 322. Further, the gradient 324 may be used to update the gradient 316 obtained in the previous stage 316. In other words, the overall gradient 340 may be determined based on the sum of gradients 314 and 324. When there are more groups, gradients from training data from other groups may be determined in a similar manner. Further, the gradients of training data from different groups may be accumulated to determine the gradients caused by all N training data.

It will be understood that the above only takes the contrastive learning model 250, which describes the forward association relationship from images to texts, as an example to introduce the specific formulas for determining the update gradient. Alternatively and/or additionally, the contrastive learning model 250 may describe the backward association relationship from texts to images. At this point, the positions of the image (I) and text (T) in the formulas 7 and 8 may be swapped, and the update gradient of the contrastive learning model 250 describing the backward association relationship may be determined based on formulas 9 and 10 as follows. Specifically, based on the formulas 2 and 5 above, the gradient of the loss of all N training data for the parameter (θ) of the contrastive learning model may be determined (see the formula 9). In the formula 9, the symbols i and j are swapped through equivalent changes in the last step. Further, a formula 10 may be determined based on mathematical transformations.

$$\begin{matrix}{∇}_{θ} {ℒ}^{T 2 I} = {\sum }_{{i}^{( T )}} {\sum }_{{j}^{( I )}} ( {\overline{p}}_{i j}^{T 2 I} - {y}_{i j}^{T 2 I} ) {\overline{s}}_{i} ( T ) {∇}_{θ} {s}_{j} ( I ) + {\sum }_{{i}^{( T )}} {\sum }_{{j}^{( I )}} ( {\overline{p}}_{i j}^{T 2 I} - {y}_{i j}^{T 2 I} ) {\overline{s}}_{j} ( I ) {∇}_{θ} {s}_{i} ( T ) \\ = [ {\sum }_{{j}^{( I )}}^{{B}^{( I )}} {∇}_{θ} {( {\sum }_{{i}^{( I )}}^{{B}^{( T )}} ( {\overline{p}}_{i j}^{T 2 I} - {y}_{i j}^{T 2 I} ) \overline{{s}_{j}} ( I ) )}^{⊤} {s}_{j} ( I ) ] + [ {\sum }_{{i}^{( T )}}^{{B}^{( T )}} {∇}_{θ} {( {\sum }_{{j}^{( I )}}^{{B}^{( I )}} ( {\overline{p}}_{i j}^{T 2 I} - {y}_{i j}^{T 2 I} ) {\overline{s}}_{j} ( I ) )}^{⊤} {s}_{i} ( T ) ] \\ = [ {\sum }_{{i}^{( I )}}^{{B}^{( I )}} {∇}_{θ} {( {\sum }_{{j}^{( I )}}^{{B}^{( T )}} ( {\overline{p}}_{j i}^{T 2 I} - {y}_{j i}^{T 2 I} ) \overline{{s}_{j}} ( T ) )}^{⊤} {s}_{i} ( I ) ] + [ {\sum }_{{j}^{( T )}}^{{B}^{( T )}} {∇}_{θ} {( {\sum }_{{i}^{( I )}}^{{B}^{( I )}} ( {\overline{p}}_{j i}^{T 2 I} - {y}_{j i}^{T 2 I} ) {\overline{s}}_{i} ( I ) )}^{⊤} {s}_{j} ( T ) ]\end{matrix} \qquad formula 9$$

$${∇}_{θ} ℒ = {∇}_{θ} {ℒ}^{T 2 I} = [ {\sum }_{{i}^{( I )}}^{{B}^{( I )}} {∇}_{θ} {( {\sum }_{{j}^{( T )}}^{{B}^{( T )}} ( {\overline{p}}_{j i}^{T 2 I} - {y}_{j i}^{T 2 I} ) {\overline{s}}_{j} ( T ) )}^{⊤} {s}_{i} ( I ) ] + [ {\sum }_{{j}^{( T )}}^{{B}^{( T )}} {∇}_{θ} {( {\sum }_{{i}^{( I )}}^{{B}^{( I )}} ( {\overline{p}}_{j i}^{T 2 I} - {y}_{j i}^{T 2 I} ) {\overline{s}}_{i} ( I ) )}^{⊤} {s}_{j} ( T ) ] \qquad formula 10$$

In the formulas 9 and 10, the meanings of each symbol are the same as the other formulas described above, so they will not be repeated. The global gradient factor 332 and the local gradient factor 312 may be determined based on the formula 10. FIG. 7 illustrates a block diagram 700 of a process for determining a contrastive learning model describing a unidirectional association relationship from texts to images according to some implementations of the present disclosure. As shown in FIG. 7, N training data may be traversed to determine a loss function 710, features 720 and 722, and then determine the global gradient factor 332. Further, M training data in the current group may be traversed to determine the local gradient factor 312. The gradient associated with the training data of each group may be determined in the manner described above, and then the overall gradient for updating the contrastive learning model 250 may be determined based on the sum of each gradient.

Alternatively and/or additionally, the contrastive learning model 250 may describe the bidirectional association relationship between images and texts. At this point, the update gradient of the contrastive learning model 250 describing the bidirectional association relationship may be determined based on a formula 11 as below. Specifically, based on the formulas 3 and 6 above, the gradient of the loss of all N training data for the parameter (θ) of the contrastive learning model may be determined (see the formula 11).

$${{∇}_{θ} ℒ = {∇}_{θ} {ℒ}^{I 2 T} + {∇}_{θ} {ℒ}^{T 2 I} = [ {\sum }_{{i}^{( I )}}^{{B}^{( I )}} {∇}_{θ} ( {\sum (}_{{j}^{( T )}}^{{B}^{( T )}} {\overline{p}}_{ij}^{I 2 T} - {y}_{ij}^{I 2 T} + {\overline{p}}_{j i}^{T 2 I} - {y}_{j i}^{T 2 I} ) {\overline{s}}_{j} ( T ) )}^{⊤} ( I ) ] + [ {\sum }_{{j}^{( T )}}^{{B}^{( T )}} {∇}_{θ} {( {\sum }_{{i}^{( I )}}^{{B}^{( I )}} ( {\overline{p}}_{ij}^{I 2 T} - {y}_{ij}^{I 2 T} + {\overline{p}}_{j i}^{T 2 I} - {y}_{j i}^{T 2 I} ) {\overline{s}}_{i} ( I ) )}^{⊤} {s}_{j} ( T ) ] \qquad formula 11$$

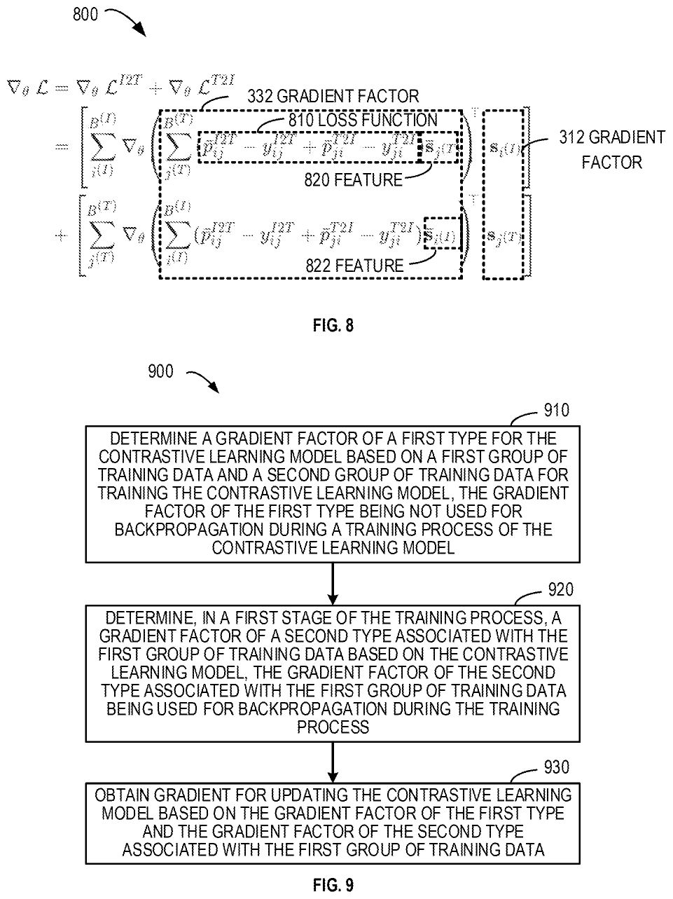

In the formula 11, the meanings of each symbol are the same as the other formulas described above, so they will not be repeated. The global gradient factor 332 and the local gradient factor 312 may be determined based on the formula 11. FIG. 8 illustrates a block diagram 800 of a process for determining update gradients based on the bidirectional association relationship between images and texts according to some implementations of the present disclosure. As shown in FIG. 8, N training data may be traversed to determine a loss function 810, features 820 and 822, and then determine the global gradient factor 332. Further, M training data in the current group may be traversed to determine the local gradient factor 312. The gradient associated with the training data of each group may be determined in the manner described above, and then the overall gradient for updating the contrastive learning model 250 may be determined based on the sum of each gradient.

By utilizing the technical solution described above, a large amount of training data may be divided into multiple groups. The training data in each group may be processed one by one in different batches to obtain an overall gradient for updating the parameters of the contrastive learning model 250. It will be understood that during the iterative training process, a certain or some network nodes in the contrastive learning model may be discarded based on predetermined rules (such as random) to alleviate overfitting problems during the training process and thereby improve the accuracy of the contrastive learning model 250.

Considering the randomness discarded during the training process, the contrastive learning model will experience two forward propagations (i.e., the process of determining the global gradient factor and the process of determining the local gradient factor involve two forward propagations). In the case of random discarding, there will be differences in the results obtained from the two forward propagations, which leads to the inability to strictly guarantee the correctness of forward propagation in mathematics. Therefore, during the first forward propagation, a predetermined random seed should be set for each group. Before the second forward propagation, the previously set seed may be loaded to ensure strict consistency between the two forward propagation results of the contrastive learning model.

According to an example implementation of the present disclosure, a discarding rule associated with the first group of training data may be determined, which defines a group of network nodes in the contrastive learning model that should be discarded during the training process. It will be understood that the discarding rule here is defined separately for different groups, and different network nodes may be discarded during different training stages when processing training data for different groups. For example, in the training stage 316 of processing the first group of training data 310, the current time may be used as the seed of the random number generator to determine which nodes should be discarded. Further, in the process of processing the first group of training data 310, the gradient factor of the first type and the gradient factor of the second type may be determined based on other network nodes in the contrastive learning model, except for a group of network nodes. For example, certain network nodes in the contrastive learning model may be hidden. In this way, the accuracy of the contrastive learning model 250 may be ensured.

The specific process of determining the update gradient of the contrast learning model 250 has been described above, and how to implement the above process in the form of computer code will be described below. According to an example implementation of the present disclosure, the process of formula 11 may be implemented based on the algorithm shown in Table 1 below.

TABLE 1
Algorithms for determining the update gradient

| | |
|---|---|
| 1 | # pre-computing stage |
| 2 | For N samples in full-batch: |
| 3 | rand_seed[sub_batch_id] = current_time( ) |
| 4 | set_rand_seed(rand_seed[sub_batch_id]) |
| 5 | For image-text pair (x_i_I, x_i_T) in each M sub-batch : |
| 6 | cache s_i_I_stopgrad = image_model.forward(x_i_I) |
| 7 | cache s_i_T_stopgrad = text_model.forward(x_i_T) |
| 8 | |
| 9 | For s_i_I_stopgrad in full-batch : |
| 10 | cache p_ij_I2T_stopgrad = softmax_I2T(s_i_I_stopgrad) |
| 11 | cache p_ij_T2I_stopgrad = softmax_T2I(s_i_T_stopgrad) |
| 12 | |
| 13 | # gradient accumulation stage |
| 14 | grad = 0 |
| 15 | For N samples in full-batch: |
| 16 | loss_alter = 0 |
| 17 | set_rand_seed(rand_seed[sub_batch_id]) |
| 18 | For image-text pair (x_i_I, x_i_T) in each M sub-batch |
| 19 | left_I = sum_j_T((p_ij_I2T_stopgrad −y_ij_I2T + |

p_ji_T2I_stopgrad −y_ji_T2I) * s_j_T_stopgrad)

| | |
|---|---|
| 20 | left_T = sum_j_I((p_ji_I2T_stopgrad −y_ji_I2T + |

p_ij_T2I_stopgrad −y_ij_T2I) * s_j_I_stopgrad)

| | |
|---|---|
| 21 | s_i_I = image_model.forward(x_i_I) |
| 22 | s_i_T = text_model.forward(x_i_T) |
| 23 | loss_alter += left_I.dot(s_i_I) + left_T.dot(s_i_T) |
| 24 | g = loss_alter.backward( ) |
| 25 | grad = grad + g |
| 26 | return grad |

As shown in Table 1, lines 1 to 7 represent the process of traversing all N training samples and determining features 820 and 822, respectively. Lines 9 to 11 show the process of determining a loss function 810. Lines 13 to 25 show the gradient accumulation process, with the symbol “grad” indicating the overall gradient and the initial value set to 0. Further, the gradients associated with the current M training data may be determined based on the formula 11, and the overall gradient grad may be obtained by summing the determined gradients. It will be understood that Table 1 illustrates the brief process of gradient determination in the form of Pseudocode, and specific codes may be written based on different programming languages, which will not be repeated herein. Generally, the algorithms shown in Table 1 may include the following steps:
1. Divide large groups containing N training data into N/M groups, with each group containing M training data:
1.1. Use the current time as a random seed for the current group: rand_seed [sub_batch_id]=current_time( )
1.2. Set the seed of the current random number generator as the seed of the new record: set_rand_seed (rand_seed [sub_batch_id]);
1.3. For each training data (xᵢ(I), xᵢ(T)) in each group:
1.3.1. Use the encoder of the first modality to obtain and record feature s̅ᵢ(I)=f_{I}(xᵢ(I));
1.3.2. Use the encoder of the second modality to obtain and record feature s̅ᵢ(T)=f_{T}(xᵢ(T));
2. For features (s̅ᵢ(I),s̅ᵢ(T)) of two modalities of all N training data:
2.1. Calculate and record

$${\overline{p}}_{i j}^{I 2 T} = \frac{exp ( {\overline{s}}_{i}^{⊤} ( I ) {\overline{s}}_{j} ( T ) )}{{\sum }_{k} exp ( {\overline{s}}_{i}^{⊤} ( I ) {\overline{s}}_{k} ( T ) )} ;$$

2.2. Calculate and record

$${\overline{p}}_{i j}^{T 2 I} = \frac{exp ( {\overline{s}}_{i}^{⊤} ( I ) {\overline{s}}_{j} ( I ) )}{{\sum }_{k} exp ( {\overline{s}}_{i}^{⊤} ( T ) {\overline{s}}_{k} ( I ) )} ;$$

3. Set the overall gradient grad to 0;
4. Divide the large group containing N samples into N/M groups:
4.1. Set [symbol] ′ to 0;
4.2. Set the seed of the current random number generator to the recorded seed: set_rand_seed (rand_seed [sub_batch_id]);
4.3. For each training data (xᵢ(I), xᵢ(T)) in each group:
4.3.1. Calculate left_{I}=Σⱼ_{^{(T)}}^{B}^{^{(T)}}(p̅ᵢⱼ^{-I2T}−yᵢⱼ^{I2T}+p̅ⱼᵢ^{-T2I}−yⱼᵢ^{T2I})s̅ⱼ(T);
4.3.2. Calculate left_{T}=Σᵢ_{^{(I)}}^{B}^{^{(I)}}(p̅ᵢⱼ^{-I2T}−yᵢⱼ^{I2T}+p̅ⱼᵢ^{-T2I}−yⱼᵢ^{T2I})s̅ᵢ(I);
4.3.3. Perform forward propagation for the contrastive learning model 250, and use the encoder of the first modality to obtain the corresponding feature s̅ᵢ(I)=f_{I}(xᵢ(I));
4.3.4. Perform forward propagation for the contrastive learning model 250, and use the encoder of the second modality to obtain the corresponding feature s̅ᵢ(T)=f_{T}(xᵢ(T));
4.3.5. Calculate [symbol] ′= [symbol] ′+ [symbol] sᵢ(I)+ [symbol] sᵢ(I).
4.4. Perform a backward process based on equivalent loss [symbol] ′ to obtain the gradient g generated by the loss of M samples in the current group;
4.5. Accumulate the gradient grad=grad+g generated by M samples in the current group;
5. Return the overall gradient grad generated by all N samples.

By utilizing the example implementation of the present disclosure, a large group containing a large amount of training data may be split into multiple smaller groups supported by the current computing device. In the process of determining the update gradient, only the training data in each smaller group needs to be loaded sequentially to obtain the gradient generated by all the training data.

The specific details of determining the update gradient during the training process have been described above. Alternatively and/or additionally, the process described above may be used to determine the update gradient for training the contrastive learning model, and then the trained contrastive learning model may be used to process the sample data. For example, the sample data that is to be processed may be inputted into the trained contrastive learning model, and the trained contrastive learning model may determine the association relationship between the data in the samples to be processed based on accurate knowledge obtained during the training stage. For example, when the sample to be processed involves two modalities (such as text and image), the trained contrastive learning model may determine whether the two modalities are consistent.

### Example Process

The specific process of determining the update gradient of the contrastive learning model has been described above. In the following, the corresponding method will be described with reference to FIG. 9. FIG. 9 illustrates a flowchart of a method 900 for determining the update gradient of the contrastive learning model according to some implementations of the present disclosure. At block 910, based on a first group of training data and a second group of training data for training the contrastive learning model, a gradient factor of a first type is determined for the contrastive learning model. At block 920, in the first stage of the training process, a gradient factor of a second type associated with the first group of training data is determined based on the contrastive learning model, and the gradient factor of the second type associated with the first group of training data being used for backpropagation during the training process. At block 930, the gradient for updating the contrastive learning model is obtained based on the gradient factor of the first type and the gradient factor of the second type associated with the first group of training data.

According to an example implementation of the present disclosure, the training data in the first group of training data and the second group of training data comprises: data of a first modality, data of a second modality, and a label representing an association relationship between the data of the first modality and the data of the second modality.

According to an example implementation of the present disclosure, the method 900 comprises: determining a loss function associated with the training data; determining, using the contrastive learning model, a first feature for the data of the first modality and a second feature for the data of the second modality, respectively; and determining the gradient factor of the first type based on the loss function, the first feature and the second feature.

According to an example implementation of the present disclosure, the method 900 comprises: determining a predicted value associated with the training data using the contrastive learning model; and determining the loss function based on a difference between the predicted value and the label in the training data.

According to an example implementation of the present disclosure, the method 900 comprises: determining the first feature and the second feature based on a first encoder and a second encoder in the contrastive learning model, respectively, the first encoder describing an association relationship between the data of the first modality and the feature of the data of the first modality, and the second encoder describing an association relationship between the data of the second modality and the feature of the data of the second modality.

According to an example implementation of the present disclosure, the gradient factor of the second type associated with the first group of training data comprises a feature of the data of the first modality and a feature of the data of the second modality in the training data of the first group of training data, and the method further comprises: determining the feature of the data of the first modality and the feature of the data of the second modality in the training data based on the first encoder and the second encoder, respectively.

According to an example implementation of the present disclosure, the method 900 further comprises: determining, in a second stage after the first stage of the training process, a gradient factor of the second type associated with the second group of training data based on the contrastive learning model and the second group of training data; and wherein obtaining the gradient further comprises: updating the gradient based on the gradient factor of the first type and the gradient factor of the second type associated with the second group of training data.

According to an example implementation of the present disclosure, the method 900 further includes: determining a discard rule associated with the first group of training data, the discard rule specifying a group of network nodes in the contrastive learning model that should be discarded during the training process; and determining the gradient factor of the first type and the gradient factor of the second type based on a network node other than the group of network nodes in the contrastive learning model.

According to an example implementation of the present disclosure, the method 900 further comprises: obtaining a positive sample of training data from a training dataset for the contrastive learning model; determining a first data of the first modality and a second data of the second modality in the positive sample; selecting a third data of the second modality from a data space of the second modality, the third data being different from the second data; and generating a negative sample in the first group of training data based on the first data of the first modality and the third data of the second modality.

According to an example implementation of the present disclosure, the contrastive learning model describes a forward association relationship from the data of the first modality to the data of the second modality.

According to an example implementation of the present disclosure, the contrastive learning model further describes a backward association relationship from the data of the second modality to the data of the first modality.

According to an example implementation of the present disclosure, the first modality comprises any of a plurality of modalities: image, text, video, audio, and the second modality comprises a further one of the plurality of modalities.

According to an example implementation of the present disclosure, a method for data processing is provided. The method comprises: determining update gradient for a contrastive learning model using the method 900 described above; training the contrastive learning model based on the update gradient; and determining an association relationship between data in a sample to be processed using the trained contrastive learning model.

### Example Apparatus and Device

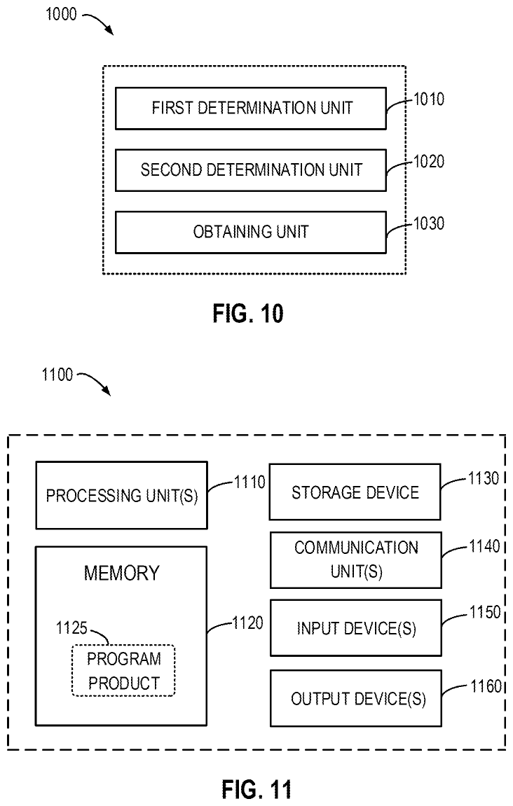

FIG. 10 illustrates a block diagram of an apparatus 1000 for determining the update gradient of the contrastive learning model according to some implementations of the present disclosure. The apparatus 1000 includes a first determination unit 1010 configured to determine a gradient factor of a first type for the contrastive learning model based on a first group of training data and a second group of training data for training the contrastive learning model, the gradient factor of the first type being not used for backpropagation during a training process of the contrastive learning model; a second determination unit 1020 configured to determine, in a first stage of the training process, a gradient factor of a second type associated with the first group of training data based on the contrastive learning model, the gradient factor of the second type associated with the first group of training data being used for the backpropagation during the training process; and a obtaining unit 1030 configured to obtain gradient for updating the contrastive learning model based on the gradient factor of the type and the gradient factor of second type associated with the first group of training data.

According to an example implementation of the present disclosure, the training data in the first group of training data and the second group of training data comprises: data of a first modality, data of a second modality, and a label representing an association relationship between the data of the first modality and the data of the second modality.

According to an example implementation of the present disclosure, the first determination unit 1010 includes: a loss determination unit configured to determine a loss function associated with the training data; a feature determination unit configured to determine, using the contrastive learning model, a first feature for the data of the first modality and a second feature for the data of the second modality, respectively; and a first gradient factor determination unit configured to determine the gradient factor of the first type based on the loss function, the first feature and the second feature.

According to an example implementation of the present disclosure, the loss determination unit includes: a prediction unit configured to determine a predicted value associated with the training data using the contrastive learning model; and a loss function determination unit configured to determine the loss function based on a difference between the predicted value and the label in the training data.

According to an example implementation of the present disclosure, the feature determination unit includes an encoder unit configured to determine the first feature and the second feature based on a first encoder and a second encoder in the contrastive learning model, respectively, the first encoder describing an association relationship between the data of the first modality and the feature of the data of the first modality, and the second encoder describing an association relationship between the data of the second modality and the feature of the data of the second modality.

According to an example implementation of the present disclosure, the gradient factor of the second type associated with the first group of training data comprises a feature of the data of the first modality and a feature of the data of the second modality in the training data of the first group of training data, and the apparatus 1000 further includes: an encoder-based feature determination unit configured to determine the feature of the data of the first modality and the feature of the data of the second modality in the training data based on the first encoder and the second encoder, respectively.

According to an example implementation of the present disclosure, the second determination unit 1020 is further configured to determine, in a second stage after the first stage of the training process, a gradient factor of the second type associated with the second group of training data based on the contrastive learning model and the second group of training data; and wherein obtaining the gradient further comprises: updating the gradient based on the gradient factor of the first type and the gradient factor of the second type associated with the second group of training data.

According to an example implementation of the present disclosure, the apparatus 1000 further includes: a discarding rule determination unit configured to determine a discard rule associated with the first group of training data, the discard rule specifying a group of network nodes in the contrastive learning model that should be discarded during the training process; and a gradient factor determination unit configured to determine the gradient factor of the first type and the gradient factor of the second type based on a network node other than the group of network nodes in the contrastive learning model.

According to an example implementation of the present disclosure, the apparatus 1000 further includes: a positive sample obtaining unit configured to obtain a positive sample of training data from a training dataset for the contrastive learning model; a data determination unit configured to determine a first data of the first modality and a second data of the second modality in the positive sample; a selection unit configured to select a third data of the second modality from a data space of the second modality, the third data being different from the second data; and a generation unit configured to generate a negative sample in the first group of training data based on the first data of the first modality and the third data of the second modality.

According to an example implementation of the present disclosure, the contrastive learning model describes a forward association relationship from the data of the first modality to the data of the second modality.

According to an example implementation of the present disclosure, the contrastive learning model further describes a backward association relationship from the data of the second modality to the data of the first modality.

According to an example implementation of the present disclosure, the first modality comprises any of a plurality of modalities: image, text, video, audio, and the second modality comprises a further one of the plurality of modalities.

According to an example implementation of the present disclosure, an apparatus for data processing is provided. The apparatus comprises: a determination unit configured to determine update gradient for a contrastive learning model using the above apparatus 1000; a training unit configured to train the contrastive learning model based on the update gradient; and a determination unit configured to determine an association relationship between data in a sample to be processed using the trained contrastive learning model.

FIG. 11 illustrates a block diagram of an electronic device 1100 in which one or more implementations of the present disclosure may be implemented. It should be understood that the electronic device 1100 shown in FIG. 11 is only an example and should not constitute any limitation on the functionality and scope of the implementations described herein.

As shown in FIG. 11, the electronic device 1100 is in the form of a general computing device. The components of electronic device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and can execute various processes based on the programs stored in the memory 1120. In a multiprocessor system, multiple processing units execute computer executable instructions in parallel to improve the parallel processing capability of the electronic device 1100.

The electronic device 1100 typically includes multiple computer storage medium. Such medium may be any available medium that is accessible to the electronic device 1100, including but not limited to volatile and non-volatile medium, removable and non-removable medium. The memory 1120 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 1130 may be any removable or non-removable medium, and may include a machine readable medium such as a flash drive, a disk, or any other medium, which may be used to store information and/or data (such as training data for training) and may be accessed within the electronic device 1100.

The electronic device 1100 may further include additional removable/non-removable, volatile/non-volatile storage medium. Although not shown in FIG. 11, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 1120 may include a computer program product 1125, which has one or more program units configured to perform various methods or acts of various implementations of the present disclosure.

The communication unit 1140 communicates with a further electronic device through the communication medium. In addition, functions of components in the electronic device 1100 may be implemented by a single computing cluster or multiple computing machines, which can communicate through a communication connection. Therefore, the electronic device 1100 may be operated in a networking environment using a logical connection with one or more other servers, a network personal computer (PC), or another network node.

The input device 1150 may be one or more input devices, such as a mouse, a keyboard, a trackball, etc. The output device 1160 may be one or more output devices, such as a display, a speaker, a printer, etc. The electronic device 1100 may also communicate with one or more external devices (not shown) through the communication unit 1140 as required. The external device, such as a storage device, a display device, etc., communicate with one or more devices that enable users to interact with the electronic device 1100, or communicate with any device (for example, a network card, a modem, etc.) that makes the electronic device 1100 communicate with one or more other electronic devices. Such communication may be executed via an input/output (I/O) interface (not shown).

According to example implementation of the present disclosure, a computer-readable storage medium is provided, on which a computer-executable instruction or computer program is stored, wherein the computer-executable instructions is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium containing the instructions includes a product, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a unit, a program segment or instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware -based system that performs the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to ordinary skill in the art. The selection of terms used in the present disclosure aims to best explain the principles, practical application or improvement of technology in the market of each implementation, or to enable other ordinary skill in the art to understand the various implementations disclosed herein.

What is claimed is:

1. A method for determining update gradient for a contrastive learning model, comprising:
determining a gradient factor of a first type for the contrastive learning model based on a first group of training data and a second group of training data for training the contrastive learning model, the gradient factor of the first type being not used for backpropagation during a training process of the contrastive learning model;
determining, in a first stage of the training process, a gradient factor of a second type associated with the first group of training data based on the contrastive learning model, the gradient factor of the second type associated with the first group of training data being used for backpropagation during the training process; and
obtaining gradient for updating the contrastive learning model based on the gradient factor of the first type and the gradient factor of the second type associated with the first group of training data.

2. The method according to claim 1, wherein training data in the first group of training data and the second group of training data comprises: data of a first modality, data of a second modality, and a label representing an association relationship between the data of the first modality and the data of the second modality.

3. The method according to claim 2, wherein determining the gradient factor of the first type comprises:
determining a loss function associated with the training data;
determining, using the contrastive learning model, a first feature for the data of the first modality and a second feature for the data of the second modality, respectively; and
determining the gradient factor of the first type based on the loss function, the first feature and the second feature.

4. The method according to claim 3, wherein determining the loss function comprises:
determining a predicted value associated with the training data using the contrastive learning model; and
determining the loss function based on a difference between the predicted value and the label in the training data.

5. The method according to claim 4, wherein determining the first feature and the second feature comprises:
determining the first feature and the second feature based on a first encoder and a second encoder in the contrastive learning model, respectively, the first encoder describing an association relationship between the data of the first modality and the feature of the data of the first modality, and the second encoder describing an association relationship between the data of the second modality and the feature of the data of the second modality.

6. The method according to claim 5, wherein the gradient factor of the second type associated with the first group of training data comprises a feature of the data of the first modality and a feature of the data of the second modality in the training data of the first group of training data, and the method further comprises: determining the feature of the data of the first modality and the feature of the data of the second modality in the training data based on the first encoder and the second encoder, respectively.

7. The method according to claim 1, further comprising: determining, in a second stage after the first stage of the training process, a gradient factor of the second type associated with the second group of training data based on the contrastive learning model and the second group of training data; and
wherein obtaining the gradient further comprises: updating the gradient based on the gradient factor of the first type and the gradient factor of the second type associated with the second group of training data.

8. The method according to claim 1, further comprising:
determining a discard rule associated with the first group of training data, the discard rule specifying a group of network nodes in the contrastive learning model that should be discarded during the training process; and
determining the gradient factor of the first type and the gradient factor of the second type based on a network node other than the group of network nodes in the contrastive learning model.

9. The method according to claim 2, further comprising: obtaining the first group of training data by:
obtaining a positive sample of training data from a training dataset for the contrastive learning model;
determining a first data of the first modality and a second data of the second modality in the positive sample;
selecting a third data of the second modality from a data space of the second modality, the third data being different from the second data; and
generating a negative sample in the first group of training data based on the first data of the first modality and the third data of the second modality.

10. The method according to claim 2, wherein the contrastive learning model describes a forward association relationship from the data of the first modality to the data of the second modality.

11. The method of claim 10, wherein the contrastive learning model further describes a backward association relationship from the data of the second modality to the data of the first modality.

12. The method according to claim 2, wherein the first modality comprises any of a plurality of modalities: image, text, video, audio, and the second modality comprises a further one of the plurality of modalities.

13. The method according to claim 1, further comprising:
training the contrastive learning model based on the gradient; and
determining an association relationship between data in a sample that is to be processed using the trained contrastive learning model.

14. An electronic device, comprising:
at least one processing unit; and
at least one memory coupled to the at least one processing unit and storing instructions to be executed by the at least one processing unit, the instructions, when executed by the at least one processing unit, causing the device to perform a method, comprising:
determining a gradient factor of a first type for the contrastive learning model based on a first group of training data and a second group of training data for training the contrastive learning model, the gradient factor of the first type being not used for backpropagation during a training process of the contrastive learning model;
determining, in a first stage of the training process, a gradient factor of a second type associated with the first group of training data based on the contrastive learning model, the gradient factor of the second type associated with the first group of training data being used for backpropagation during the training process; and
obtaining gradient for updating the contrastive learning model based on the gradient factor of the first type and the gradient factor of the second type associated with the first group of training data.

15. The device according to claim 14, wherein training data in the first group of training data and the second group of training data comprises: data of a first modality, data of a second modality, and a label representing an association relationship between the data of the first modality and the data of the second modality.

16. The device according to claim 15, wherein determining the gradient factor of the first type comprises:
determining a loss function associated with the training data;
determining, using the contrastive learning model, a first feature for the data of the first modality and a second feature for the data of the second modality, respectively; and
determining the gradient factor of the first type based on the loss function, the first feature and the second feature.

17. The device according to claim 16, wherein determining the loss function comprises:
determining a predicted value associated with the training data using the contrastive learning model; and
determining the loss function based on a difference between the predicted value and the label in the training data.

18. The device according to claim 17, wherein determining the first feature and the second feature comprises:
determining the first feature and the second feature based on a first encoder and a second encoder in the contrastive learning model, respectively, the first encoder describing an association relationship between the data of the first modality and the feature of the data of the first modality, and the second encoder describing an association relationship between the data of the second modality and the feature of the data of the second modality.

19. The device according to claim 14, wherein the method further comprises:
training the contrastive learning model based on the gradient; and
determining an association relationship between data in a sample to be processed using the trained contrastive learning model.

20. A non-transitory computer-readable storage medium storing a computer program thereon, the computer program, when executed by a processor, performing a method, comprising:
determining a gradient factor of a first type for the contrastive learning model based on a first group of training data and a second group of training data for training the contrastive learning model, the gradient factor of the first type being not used for backpropagation during a training process of the contrastive learning model;
determining, in a first stage of the training process, a gradient factor of a second type associated with the first group of training data based on the contrastive learning model, the gradient factor of the second type associated with the first group of training data being used for backpropagation during the training process; and
obtaining gradient for updating the contrastive learning model based on the gradient factor of the first type and the gradient factor of the second type associated with the first group of training data.
